(19) United States
(12) Patent Application Publication
(10) Pub. No.: US 2021/0197375 A1
(43) Pub. Date: Jul. 1, 2021

(54) ROBOT AND METHOD FOR OPERATING A ROBOT

(71) Applicant: FRANKA EMIKA GMBH, München (DE)

(72) Inventor: Sami Haddadin, Hannover (DE)

(21) Appl. No.: 16/065,529

(22) PCT Filed: Dec. 27, 2016
(86) PCT No.: PCT/EP2016/082690

§ 371 Date: Jun. 22, 2018

(30) Foreign Application Priority Data
Dec. 30, 2015 (DE) 10 2015 122 998.6

(51) Int. Cl. B25J 9/16

(52) U.S. Cl. CPC B25J 9/1664; B25J 9/1694

(57) ABSTRACT

The invention relates to a method for operating a robot and to a robot, wherein the robot comprises movable elements ELEₘ which can be driven by actuators AKTₙ, and is designed to carry out a movement B with the elements ELEₘ, and wherein the robot comprises a detection system for determining signals W_{G}_{ₖ}_{^{B}}(t) of a group of measurement variables Gₖ^{B} characterizing the movement B of the elements ELEₘ and the interactions thereof with an environment. The proposed method comprises the following steps: determining (10), by means of the detection system, reference signals W_{G}_{ₖ}_{^{B}}^{R}(t) of the measurement variables Gₖ^{B} during at least one execution of the movement B of the elements ELEₘ which is in the form of a reference movement B; automatically determining (102), based on the reference signals W_{G}_{ₖ}_{^{B}}^{R} (t), using an adaptive method, a mathematical model M_{G}_{ₖ}_{^{B}} for describing the reference movement B including the reference interactions by the measurement variables Gₖ^{B}, during a normal execution of the movement B by the model M_{G}_{ₖ}_{^{B}}; predicting (103) signals W_{G}_{ₖ}_{^{B}}^{P}(t) for describing the reference movement B, including the reference interactions by the measurement variables Gₖ^{B}; comparing (104) the signals W_{G}_{ₖ}_{^{B}}(t) determined currently during the normal execution of the movement B with the predicted signals W_{G}_{ₖ}_{^{B}}(t) for determining a deviation Δ_{G}_{ₖ}_{^{B}}(t) between W_{G}_{ₖ}_{^{B}}^{P}(t) and in W_{G}_{ₖ}_{^{B}}; insofar as the deviation Δ_{G}_{ₖ}_{^{B}}(t) does not meet a predefined condition BED_{G}_{ₖ}_{^{B}}, based on the deviation Δ_{G}_{ₖ}_{^{B}}(t) classifying (105) the current deviation Δ_{G}_{ₖ}_{^{B}}(t) in one of a number I of predefined error categories F_{i,G}_{ₖ}_{^{B}}(Δ_{G}_{ₖ}_{^{B}}(t)), wherein predefined control information S_{F}_{ᵢ}_{,G}_{ₖ}_{^{B}}(t) for the actuators AKTₖ is produced for each of the error categories F_{i,G}_{ₖ}_{^{B}}(Δ_{G}_{ₖ}_{^{B}}(t)), and controlling (106) the actuators AKTₖ taking into account the control information S_{F}_{ᵢ}_{,G}_{ₖ}_{^{B}}(t).

### CROSS-REFERENCE TO RELATED APPLICATIONS

This application is the U.S. National Phase of International Patent Application No. PCT/EP2016/082690, filed on 27 Dec. 2016, which claims benefit of German Patent Application No. 102015122998.6, filed on 30 Dec. 2015, the contents of which are incorporated herein by reference in their entirety.

### BACKGROUND

### Field

The invention relates to a method for operating a robot, wherein the robot includes movable elements which can be driven by actuators and is designed to carry out a movement B with the movable elements.

### Related Art

As is known, robots are used increasingly in sectors in which, in performing a predefined task, the robot carries out, via the movable elements thereof, for example a robot arm, a movement B with the movable elements thereof and in the process interacts mechanically with its environment. Due to the interaction with the environment, in particular forces and/or torques, but also other physical parameters such as, for example, heat, electrical or magnetic fields, etc., are transferred to the movable elements through the environment.

The environment can include stationary or mobile objects. In particular, the environment can be a human interacting with the movable elements of the robot. In the process, in order to accomplish different tasks, a robot can carry out a plurality of different movements B with the movable elements thereof, which can be driven by an actuator, movements B which in turn each individually include an interaction with the environment. In the present case, the term “interaction” describes the (usually mechanical) interaction with the environment of the robot, which occurs in the case of the task-appropriate execution of the movement B. The “interaction” can be defined, for example, by a predefined range of a force input or of a torque input, a heat input, a pulse input, a radiation input, etc., into the movable elements during the execution of a predefined movement B.

### SUMMARY

The aim of the invention is to present a method for operating a robot, and a robot, which are capable of distinguishing, during the execution of a movement B, desired interactions from undesired interactions with an environment and with the human, and which are capable of actuating the movable elements accordingly.

The invention results from the features of the independent claims. Advantageous developments and designs are the subject matter of the dependent claims. Additional features, application possibilities and advantages of the invention result from the following description as well as from the explanation of embodiment examples of the invention, which are represented in the FIGURE.

The process aspect of the aim is achieved by a method for operating a robot, wherein the robot includes movable elements ELEₘ which can be driven by actuators AKTₙ, and is designed to carry out a movement B with the elements ELEₘ, where n=1, 2, . . . , N, m=1, 2 . . . , M, N=1, 2, . . . , M=1, 2, . . . , and wherein the robot includes a detection system for determining signals W_{G}_{ₖ}_{^{B}}(t) of a group of measurement variables Gₖ^{B}, where k=1, 2, . . . , K and K≥1, characterizing the movement B of the elements ELEₘ and the interactions thereof with an environment.

The number N of actuators AKTₙ and the number M of movable elements ELEₘ do not have to be identical (N=M). Depending on the design of the robot: N>M or N<M. In many application cases, for example when the movable elements ELEₘ form a robot arm, it is possible that N=M.

The actuators AKTₙ are, for example, electric motors, linear motors, piezoelements, pneumatic motors, hydraulic motors, hybrid drives, etc. The movable elements ELEₘ are, for example, arm members (advantageously including an optionally mounted end effector) of a robot arm.

The movement B of the elements ELEₘ is advantageously defined by trajectories which indicate a temporal course of a positional change (position and/or orientation) of the individual movable elements ELEₘ (advantageously including an end effector). The movement B can be defined alternatively or additionally by additional parameters, for example, by speeds and/or accelerations of the elements ELEₘ, by forces and/or torques generated by the actuators AKTₙ and acting on the elements ELEₘ, and/or by an electrical current and/or an electrical voltage for actuating the actuators AKTₙ, etc. An interaction of the elements ELEₘ with the environment is advantageously acquired or defined by external forces and/or external pressures and/or external torques, which act on the individual elements ELEₘ. The description of an interaction of the elements ELEₘ with the environment is selected advantageously depending on the respective physical interaction (=interaction) between environment and the elements. For example, the interaction can be a mechanical interaction, a radiation interaction, an interaction with heat transfer, with current flow, with voltage generation, etc.

Advantageously, maximum deviations of parameters which at least largely define the movement B and the interactions which are suitable for characterizing the movement B of the elements ELEₘ, including the interactions thereof with the environment (for example, by externally applied forces and/or torques and/or pressures and/or heat transfers and/or current flows) with an environment, are predefined.

The detection system for determining signals W_{G}_{ₖ}_{^{B}}(t) of a group of measurement variables Gₖ^{B}, where k=1, 2, . . . , K and K≥1, characterizing the movement B of the elements ELEₘ and the interactions thereof with the environment, advantageously includes sensors which can contain or indicate a temporal positional change of the individual movable elements ELEₘ and advantageously additional parameters such as speeds, accelerations, forces, torques, pressures, temperature, electrical current, electrical voltage, positions and all estimators of such parameters, which are suitable for characterizing the movement B of the elements ELEₘ, including the interaction/interactions thereof (as described above) with the environment.

The signals W_{G}_{ₖ}_{^{B}}(t) are advantageously determined based on raw data R_{G}_{ₖ}_{^{B}}(t) which are acquired by the sensors of the detection system and/or in which the signals W_{G}_{ₖ}_{^{B}}(t) are determined based on estimation signals. Such estimation signals can be determined, for example, by the dynamic models describing the robot and/or by suitable observer or estimation structures. Advantageously, in particular, the determination of the signals W_{G}_{ₖ}_{^{B}}(t) is made from a combination of measured raw data R_{G}_{ₖ}_{^{B}}(t) and estimation signals. Thereby, the noise portion of the measured raw data R_{G}_{ₖ}_{^{B}}(t) can be reduced, and the robustness and the accuracy of the determined signals W_{G}_{ₖ}_{^{B}}(t) can be increased.

The group of (physical) measurement variables Gₖ^{B} includes a number of K measurement variables which can differ for different movements B. That is, for two different movements B₁ and B₂, and respective associated desired or allowed interactions with the environment, the number K of the measurement variables as well as the selection of the measurement variables itself can be different (K₁≠K₂). For the sake of simplicity, it is assumed here that a task-appropriate movement B also has an unequivocal assignment of desired or allowed interactions with an environment.

The measurement variables Gₖ^{B} advantageously include, for example, positions and/or speeds of individual or all of the movable elements ELEₘ, individual or all of the external forces and/or external torques and/or pressures acting on the individual movable elements ELEₘ, individual or all of the electrical currents and/or electrical voltages for actuating the actuators AKTₙ, which in turn can correspond to drive torques.

The number K and the selection of the physical measurement variables Gₖ^{B} are advantageously predefined separately and in an optimized manner for each movement B, including the associated interactions with the environment. By the optimization of a suitable selection of the measurement variables Gₖ^{B}, the number K of the measurement variables Gₖ^{B} can advantageously be minimized, without thereby resulting in a characterization of the movement B including the associated interactions with the environment.

The proposed method includes the following steps. In a step, using the detection system, a determination of reference signals W_{G}_{ₖ}_{^{B}}^{R}(t) of the measurement variables Gₖ^{B} occurs in the case of at least one execution of the movement B of the elements ELEₘ in the form of a reference movement B, wherein the reference movement B also includes reference interactions of the elements ELEₘ with an environment, in particular external forces and/or torques acting on the elements ELEₘ.

In the present case, the term “reference interactions” refers to interactions with the environment which are necessary, desired and/or allowed during a task-appropriate execution of the movement B. In this step, a generation of reference signals W_{G}_{ₖ}_{^{B}}^{R}(t) of the measurement variables Gₖ^{B} thus occurs. The detection system is advantageously part of the robot. The sensors are advantageously connected to the elements ELEₘ and/or to the actuators AKTₙ. In a development, measurement variables Gₖ^{B} which are determined by an external detection system (for example, an external proximity sensor) are also taken into account. The number and the type of external sensors/detection system are advantageously selected depending on the task formulation and the aim.

If a movement B is to be carried out for performing a task in which the elements ELEₘ interact with an environment, for example, with a human, then, for example, the intended, desired and allowed mechanical interactions acting on the elements ELEₘ during the execution of the movement B and generated by the human are taken into account in the characterization of the movement B. It is essential that, in the determination of the reference signals W_{G}_{ₖ}_{^{B}}^{R}(t), no other interactions except for the intended or desired and allowed interactions between the environment and the elements ELEₘ are present.

Advantageously, the reference signals W_{G}_{ₖ}_{^{B}}^{R}(t) are determined based on a multiple execution of the movement B. Due to the advantageous multiple execution of the movement B, it is possible to acquire a range of the intended, desired or allowed interactions between the environment and the elements ELEₘ and to take into account any acting statistical effects and to take the movement B into account in the characterization.

In an additional step, based on the reference signals W_{G}_{ₖ}_{^{B}}^{R}(t) and using an adaptive method, an automatic determination of a mathematical model M_{G}_{ₖ}_{^{B}} for describing the reference movement B, including the reference interactions (advantageously: an allowed range of reference interactions), by the measurement variables Gₖ^{B}, occurs.

Advantageously, the modeling, i.e., the adaptive method for determining the mathematical model M_{G}_{ₖ}_{^{B}} occurs based on one or more Gaussian processes. Advantageously, the model M_{G}_{ₖ}_{^{B}} is a statistical model which is trained based on the signals W_{G}_{ₖ}_{^{B}}^{R}(t). Moreover, the statistical model M_{G}_{ₖ}_{^{B}} advantageously includes a so-called hidden Markov model HMM and/or a so-called support vector machine SVM (English for “Support Vector Machine”) and/or a neuronal network and/or a deep neuronal network. The modeling based on predefined reference data is known per se from the prior art. For additional details, reference is made to the relevant prior art.

During a normal execution of the movement B using the model M_{G}_{ₖ}_{^{B}}, in an additional step, a prediction of signals W_{G}_{ₖ}_{^{B}}^{P}(t) for describing the reference movement B, including the reference interactions with the environment, by the measurement variables Gₖ^{B}, occurs. The previous steps and the following steps relate to the phase of an operational, i.e., normal implementation of the proposed method. Here the model M_{G}_{ₖ}_{^{B}} determined generates predicted signals W_{G}_{ₖ}_{^{B}}^{P}(t) of the measurement variables Gₖ^{B}, in which, in particular, desired interactions of the elements ELEₙ with an environment of the robot are represented.

In an additional step, a comparison of current signals W_{G}_{ₖ}_{^{B}}(t) determined during the normal execution of the movement B with the predicted signals W_{G}_{ₖ}_{^{B}}^{P}(t) occurs for determining a deviation Δ_{G}_{ₖ}_{^{B}}(t) between W_{G}_{ₖ}_{^{B}}^{P}(t) and W_{G}_{ₖ}_{^{B}}(t), where k=1, 2, . . . , K and K≥1.

The signals W_{G}_{ₖ}_{^{B}}(t) are determined advantageously in the current normal execution of the movement B by the detection system and/or based on estimation values. The comparison can be, for example, an algebraic comparison and/or a statistical comparison of the determined signals W_{G}_{ₖ}_{^{B}}(t) with the predicted signals W_{G}_{ₖ}_{^{B}}^{P}(t) or a combination thereof.

In an additional step, insofar as the deviation Δ_{G}_{ₖ}_{^{B}}(t) does not meet a predefined condition BED_{G}_{ₖ}_{^{B}}, based on the deviation Δ_{G}_{ₖ}_{^{B}}(t), a classifying of the currently occurring deviation Δ_{G}_{ₖ}_{^{B}}(t) in one of a number I of predefined error categories F_{i,G}_{ₖ}_{^{B}}(Δ_{G}_{ₖ}_{^{B}}(t)) occurs, where i=1, 2, . . . , I, wherein, for each of the error categories F_{i,G}_{ₖ}_{^{B}}(Δ_{G}_{ₖ}_{^{B}}(t)), predefined control information S_{F}_{ᵢ}_{,G}_{ₖ}_{^{B}}(t) for the actuators AKTₖ is provided. The condition BED_{G}_{ₖ}_{^{B}} can also be time-variant: BED_{G}_{ₖ}_{^{B}}(t).

Here it is assumed that, for any deviation Δ_{G}_{ₖ}_{^{B}}(t), corresponding control information S_{F}_{ᵢ}_{G}_{ₖ}_{^{B}}(t) is provided, so that the classification is always possible. Advantageously, this also means that, for deviations which in fact do not allow a sensible classification, at least one corresponding error category F_{i,G}_{ₖ}_{^{B}}(Δ_{G}_{ₖ}_{^{B}}(t)) with corresponding predefined control information S_{F}_{ᵢ}_{,G}_{ₖ}_{^{B}}(t) is provided.

The predefined error categories F_{i,G}_{ₖ}_{^{B}}(Δ_{G}_{ₖ}_{^{B}}(t)) make it possible to classify actually occurring interactions with the environment of the robot depending on the type of interaction (for example, with regard to an intention or a difficulty of an interaction) and/or depending on the type of contact object in the environment (for example, a human, a task environment, other environment) and/or with regard to a task progress or a task completion. This is essential in particular for an integration of interactions between humans and robots in the task control when proprioceptive or tactile information based on, for example, statistical models of these interactions is used.

Advantageously, the condition BED_{G}_{ₖ}_{^{B}} specifies for at least one of the K measurement variables Gₖ^{B} that the deviation Δ_{G}_{ₖ}_{^{B}}(t) between W_{G}_{ₖ}_{^{B}}^{P}(t) and W_{G}_{ₖ}_{^{B}}(t) is smaller than/equal to a predefined limit value LIMIT_{G}_{ₖ}_{^{B}}: Δ_{G}_{ₖ}_{^{B}}(t)≤LIMIT_{G}_{ₖ}_{^{B}}. Naturally, depending on the task definition and the movement B to be performed, the conditions BED_{G}_{ₖ}_{^{B}} can be specified individually as desired in each case.

Advantageously, the control information S_{F}_{ᵢ}_{,G}_{ₖ}_{^{B}}(t) for the actuators AKTₙ defines a completed reaction movement of the elements ELEₘ driven by an actuator and/or a change of at least one of the conditions BED_{G}_{ₖ}_{^{B}} and/or a change of the model M_{G}_{ₖ}_{^{B}}.

As reaction movements, one can consider, for example, an avoidance movement, i.e., a change of the previous movement B, or a stopping of the movement B performed so far, or a stopping of a movement of individual elements ELEₘ or a switching to another control mode.

The control information S_{F}_{ᵢ}_{,G}_{ₖ}_{^{B}}(t) can also relate to the current execution of the movement B; for example, the movement speed of the current movement B can be reduced. In the latter case, the actuators AKTₙ, for example of a predefined control program, are controlled for executing a nominal task taking into account the control information S_{F}_{ᵢ}_{,G}_{ₖ}_{^{B}}(t). The control information S_{F}_{ᵢ}_{,G}_{ₖ}_{^{B}}(t) can also represent the only source of control information of the actuators AKTₙ. The control information S_{F}_{ᵢ}_{,G}_{ₖ}_{^{B}}(t) can also generate a change of all the other executions of the movement B (for example, the driving of the actuators AKTₙ for the rest of the current movement B or for all the other executions of the movement B can be changed in such a manner that the yieldingness with respect to external mechanical contacts is increased). Depending on the task formulation and the aim, the control information S_{F}_{ᵢ}_{,G}_{ₖ}_{^{B}}(t) can be selected or automatically planned.

In an additional step, a control of the actuators AKTₖ occurs taking into account the control information S_{F}_{ᵢ}_{,G}_{ₖ}_{^{B}}(t).

Advantageously, the movable elements ELEₘ form arm members of a robot arm, wherein at least some of the elements ELEₘ are driven by the actuators AKTₖ and wherein the detection system acquires the measurement variables Gₖ^{B} in each case for some or all of the arm members.

The proposed method makes it possible, in particular in the case of execution of a movement B, to distinguish desired interactions from undesired interactions with an environment of the robot and to accordingly control the movable elements ELEₘ or the actuators AKTₙ driving them as a function of a characterization of the actually occurring interactions.

The proposed method moreover enables, for example, an automatic indication of task-dependent contact thresholds and signal profiles, which, in addition to an undisturbed execution of a movement B by the elements ELEₘ, also takes into account interactions of the elements ELEₘ with an environment of the robot.

Advantageously, the proposed method is based on analytical dynamic models, possibly enhanced by statistical models (friction, noise, model imprecision, . . . ) and a proprioceptive detection system, and it enables the integration of external sensors. It enables the integration and use of currently occurring mechanical contact information for a planned mechanical interaction between the robot and a human as well as the detection, isolation and classification of undesired/allowed interactions and the generation of corresponding reactions by controlling the actuators AKTₖ taking into account the control information S_{F}_{ᵢ}_{,G}_{ₖ}_{^{B}}(t).

Incorrect configurations for execution of a movement B and errors in the case of the current execution of a movement B can thereby be identified and classified online.

In the case of operational, i.e., normal, execution of the movement B, the method thus functions virtually as observed and it can easily be integrated in complex manipulation tasks without the need to intervene in the task/movement course and the tasks of the environment.

An analytical modeling of complex interactions of human and robot is largely impossible. Therefore, a probabilistic modeling linked with existing analytical models with verified empirical data as obtained by a correct execution of the task-appropriate movement B is advantageously proposed. Such a model acquires the system properties by using statistical indications such as, for example, by using confidence intervals. Advantageously, in the proposed method, error detection and isolation using probabilistic approaches occur. This allows the use of a large method building set including, for example, statistical learning methods such as decision trees or linear classification models.

The proposed method can moreover be transferred between similar movements B if the methods used are parameterized in a task-specific manner. Moreover, the proposed method can be transferred between robot categories if the methods used are parameterized in a robot-specific manner.

The aim of the invention is achieved moreover by a computer system with a data processing device, wherein the data processing device is designed in such a manner that a method, as described above, is carried out on the data processing device.

In addition, the aim of the invention is achieved by a digital storage medium with electronically readable control signals, wherein the control signals can interact with a programmable computer system in such a manner that a method, as described above, is carried out.

Furthermore, the aim of the invention is achieved by a computer program product with a program code stored on a machine-readable medium, for carrying out the method, as described above, when the program code is executed on a data processing device.

Finally, the invention relates to a computer program with program codes for carrying out the method, as described above, when the program runs on a data processing device. For this purpose the data processing device can be designed as any computer system known from the prior art.

Below, a general example of the method will be explained in addition. In principle, the method includes the following general steps. In a first step, a generation of reference signals by advantageous multiple execution of reference movement B including associated reference interactions with the environment of the robot occurs. In the process, a recording of the task-relevant reference signals in running operation and advantageously a preliminary processing of the reference signals occur in a task-dependent manner. In the concrete case, this can include, for example:
a recording of data on external torques and speeds of the elements ELEₙ during the multiple execution of the reference movement B including associated reference interactions with the environment,
an interpolation of lacking data points,
an orientation of the different acquired data sets of the same reference movement B and identification of information-rich points in the data sets.

Subsequently, a modeling by an adaptive method occurs. This includes, for example, a task- and signal-dependent selection of the modeling method, a transfer of the previously acquired reference signals to the selected adaptive method, a generation of the model on the signal plane from the perspective of the use of the model during running operation. In the concrete case, this can include:
a selection of Gaussian processes as adaptive modeling processes based on the acquired reference signals,
an application sparsification method for reducing the calculation effort in the modeling and evaluation step, and
a generation of the model by the application of a Gaussian process to the sparsified reference signals.

In an additional step, the verification of the signals acquired by the detection system during running operation of a robot occurs. This advantageously includes the execution of a so-called “Fault Detection and Isolation (FDI)” method. During the execution of the movement B, due to continuous monitoring of the signals currently acquired with the detection system, it is possible to distinguish between a nominal course of the movement B including allowed interaction with the environment, and error cases. In the concrete case, this can include:
a monitoring of the external torque signal in connection with the speed by the Gaussian process. For example, the signal must be in the 99% confidence interval around the model prediction of the signal in order to be associated with the nominal movement course B. Otherwise the situation is interpreted as an error case and the execution of the task is aborted.

In another step, a classification of the error cases occurs. In the concrete case, this can include the following: using a classification algorithm, the error cause can be narrowed down more precisely, and thus the possibility of an interpretation of the signal deviation in the task context is given.

The aim is achieved moreover by a robot, designed and implemented for carrying out a method, as described above.

Additional advantages, features and details result from the following description in which—optionally in reference to the drawing—at least one embodiment example is described in detail. Identical, similar and/or functionally equivalent parts are provided with identical reference numerals.

### BRIEF DESCRIPTION OF THE DRAWINGS

In the drawings:

FIG. 1 shows a diagrammatic course of the procedure of the proposed method.

### DETAILED DESCRIPTION

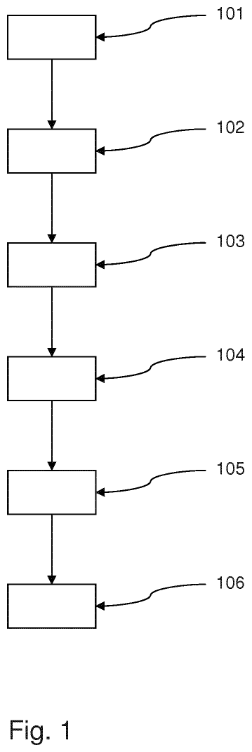

FIG. 1 shows a diagrammatic course of the procedure of the proposed method for operating a robot, wherein the robot includes movable elements ELEₘ which can be driven by actuators AKTₙ, and is designed for the execution of a movement B with the elements ELEₘ, where n=1, 2, . . . , N, m=1, 2 . . . , M, N=1, 2, . . . , M=1, 2, . . . , and wherein the robot includes a detection system for determining signals W_{G}_{ₖ}_{^{B}}(t) of a group of measurement variables Gₖ^{B} where k=1, 2, . . . , K and K≥1, characterizing the movement B of the elements ELEₘ and their interactions with an environment.

The method includes the following steps.

In a first step 101, by using the detection system, a determination of reference signals W_{G}_{ₖ}_{^{B}}^{R}(t) of the measurement variables Gₖ^{B} occurs during at least one execution of the movement B of the elements ELEₘ, which is in the form of reference movement B, wherein the reference signals W_{G}_{ₖ}_{^{B}}^{R}(t) include reference interactions of the elements ELEₘ with the environment, in particular external forces and/or torques acting on the elements ELEₘ.

In a second step 102, based on the reference signals W_{G}_{ₖ}_{^{B}}^{R}(t), by using an adaptive method, an automatic determination of a mathematical model M_{G}_{ₖ}_{^{B}} for describing the reference movement B, including the reference interactions, by the measurement variables Gₖ^{B}, occurs.

In a third step 103, during normal execution of the movement B, using the model M_{G}_{ₖ}_{^{B}} a prediction of signals W_{G}_{ₖ}_{^{B}}^{P}(t) for the description of the reference movement B, including the reference interactions, by the measurement variables Gₖ^{B}, occurs.

In a fourth step 104, a comparison of signals W_{G}_{ₖ}_{^{B}}(t) determined currently during the normal execution of the movement B with the predicted signals W_{G}_{ₖ}_{^{B}}^{P}(t) occurs for the determination of a deviation Δ_{G}_{ₖ}_{^{B}}(t) between W_{G}_{ₖ}_{^{B}}^{P}(t) and W_{G}_{ₖ}_{^{B}}(t), where k=1, 2, . . . , K and K≥1.

In a fifth step 105, insofar as the deviation Δ_{G}_{ₖ}_{^{B}}(t) does not meet a predefined condition BED_{G}_{ₖ}_{^{B}}, based on the deviation Δ_{G}_{ₖ}_{^{B}}(t), a classification of the currently occurring deviation Δ_{G}_{ₖ}_{^{B}}(t) in one of a number I of predefined error categories F_{i,G}_{ₖ}_{^{B}}(Δ_{G}_{ₖ}_{^{B}}(t)) occurs, where i=1, 2, . . . , I, wherein, for each of the error categories F_{i,G}_{ₖ}_{^{B}}(Δ_{G}_{ₖ}_{^{B}}(t)), predefined control information S_{F}_{ᵢ}_{,G}_{ₖ}_{^{B}}(t) for the actuators AKTₖ is provided.

In a sixth step 106, a controlling of the actuators AKTₖ taking into account the control information S_{F}_{ᵢ}_{,G}_{ₖ}_{^{B}}(t) occurs.

Although the invention has been illustrated in further detail and explained by a preferred embodiment example, the invention is not limited by the disclosed examples, and other variations can be derived by the person skilled in the art therefrom, without leaving the scope of protection of the invention. It is therefore clear that numerous variation possibilities exist. It is also clear that, for example, mentioned embodiments in fact represent only examples which in no way should be interpreted as a limitation, for example, of the scope of protection, the application possibilities or the configuration of the invention. Instead, the preceding description and the FIGURE description enable the person skilled in the art to concretely implement the exemplary embodiments, wherein the person skilled in the art, in the knowledge of the disclosed inventive idea, can make various changes, including with regard to the function or the arrangement, in an exemplary embodiment of mentioned elements without leaving the scope of protection defined by the claims.

1. A method of operating a robot, wherein the robot comprises movable elements ELEₘ that are drivable by actuators AKTₙ, and is designed to carry out a movement B with the elements ELEₘ, where n=1, 2, . . . , N, m=1, 2 . . . , M, N=1, 2, . . . , M=1, 2, . . . , and wherein the robot comprises a detection system to determine signals W_{G}_{ₖ}_{^{B}}(t) of a group of measurement variables Gₖ^{B}, where k=1, 2, . . . , K and K≥1, characterizing the movement B of the elements ELEₘ and interactions thereof with an environment, the method comprising:
determining, by the detection system, reference signals W_{G}_{ₖ}_{^{B}}^{R}(t) of the measurement variables Gₖ^{B} during at least one execution of the movement B of the elements ELEₘ, which is in a form of a reference movement B, wherein the reference signals W_{G}_{ₖ}_{^{B}}^{R}(t) include reference interactions of the elements ELEₘ with the environment, including external forces and/or torques acting on the elements ELEₘ;
based on the reference signals W_{G}_{ₖ}_{^{B}}^{R}(t), using an adaptive method, automatically determining a mathematical model M_{G}_{ₖ}_{^{B}} to describe the reference movement B including the reference interactions, by the measurement variables Gₖ^{B};
during a normal execution of the movement B:
using the model M_{G}_{ₖ}_{^{B}}, predicting signals W_{G}_{ₖ}_{^{B}}^{P}(t) to describe the reference movement B, including the reference interactions, by the measurement variables Gₖ^{B};
comparing the signals W_{G}_{ₖ}_{^{B}}(t) determined currently during the normal execution of the movement B with the predicted signals W_{G}_{ₖ}_{^{B}}^{P}(t) to determine a deviation Δ_{G}_{ₖ}_{^{B}}(t) between W_{G}_{ₖ}_{^{B}}^{P}(t) and W_{G}_{ₖ}_{^{B}}(t), where k=1, 2, . . . , K and K≥1;
in so far as the deviation Δ_{G}_{ₖ}_{^{B}}(t) does not meet a predefined condition BED_{G}_{ₖ}_{^{B}}, based on the deviation Δ_{G}_{ₖ}_{^{B}}(t), classifying the deviation Δ_{G}_{ₖ}_{^{B}}(t) in one of a number I of predefined error categories F_{i,G}_{ₖ}_{^{B}}(Δ_{G}_{ₖ}_{^{B}}(t)), where i=1, 2, . . . , I, wherein predefined information and/or automatically predictable control information S_{F}_{ᵢ}_{,G}_{ₖ}_{^{B}}(t) for the actuator AKTₖ are produced for each of the error categories F_{i,G}_{ₖ}_{^{B}}(Δ_{G}_{ₖ}_{^{B}}(t)); and
controlling the actuators AKTₖ taking into account the control information S_{F}_{ᵢ}_{,G}_{ₖ}_{^{B}}(t).

2. The method according to claim 1, wherein the group of measurement variables Gₖ^{B} comprises one or more of the following variables: force acting on movable robot components, torque and/or position, speed, or acceleration of the robot components, and/or pressure, temperature, energy, and/or contact points, and/or estimated contact points with an environment.

3. The method according to claim 1, wherein the movable elements ELEₘ form arm members of a robot arm, wherein at least some of the elements ELEₘ are driven by the actuators AKTₖ, and wherein the detection system in each case acquires the measurement variables Gₖ^{B} for some or all of the arm members.

4. The method according to claim 1, wherein the adaptive method in determining the mathematical model M_{G}_{ₖ}_{^{B}} is carried out based on one or more Gaussian processes.

5. The method according to claim 1, wherein the mathematical model M_{G}_{ₖ}_{^{B}} is a statistical model which is trained based on the signals W_{G}_{ₖ}_{^{B}}^{R}(t).

6. The method according to claim 5, wherein the statistical model comprises a hidden Markov model HMM and/or a support vector machine SVM and/or a neuronal network.

7. The method according to claim 1, wherein the signals W_{G}_{ₖ}_{^{B}}(t) are determined based on raw data R_{G}_{ₖ}_{^{B}}(t) acquired by the sensors of the detection system and/or wherein the signals W_{G}_{ₖ}_{^{B}}(t) are determined based on estimation signals.

8. The method according to claim 1, wherein the condition BED_{G}_{ₖ}_{^{B}} predetermines, for at least one of the measurement variables Gₖ^{B}, that the deviation Δ_{G}_{ₖ}_{^{B}}(t) between W_{G}_{ₖ}_{^{B}}^{P}(t) and W_{G}_{ₖ}_{^{B}}(t) is smaller than or equal to a predefined limit value LIMIT_{G}_{ₖ}_{^{B}}: Δ_{G}_{ₖ}_{^{B}}(t)≤LIMIT_{G}_{ₖ}_{^{B}}.

9. The method according to claim 1, wherein the control information S_{F}_{ᵢ}_{,G}_{ₖ}_{^{B}}(t) defines a completed reaction movement of the robot components and/or a change of at least one condition BED Gₖ and/or a change of the model M_{G}_{ₖ}_{^{B}}.

10. A robot designed and implemented to carry out a method according to claim 1.
